(19) United States
(12) Patent Application Publication
(10) Pub. No.: US 2026/0001606 A1
(43) Pub. Date: Jan. 1, 2026

(54) A SEAT POST AND ASSEMBLY

(71) Applicant: Property Source Solutions Pty Ltd, Brisbane, Queensland (AU)

(72) Inventor: Darren JAMES, Brisbane, Queensland (AU)

(21) Appl. No.: 18/997,031

(22) PCT Filed: Jul. 5, 2023
(86) PCT No.: PCT/AU2023/050621

§ 371 Date: Jan. 18, 2025

(30) Foreign Application Priority Data
Jul. 21, 2022 (AU) 2022206795

(51) Int. Cl. B62J 1/08

(52) U.S. Cl. CPC B62J 1/08; B62J 2001/085

(57) ABSTRACT

A seat post for a BMX bike having a first elongate portion, and a second elongate portion having a smaller external diameter than the first elongate portion, wherein the seat post steps down or tapers in diameter from the first elongate portion to the second elongate portion.

### FIELD OF INVENTION

The present invention relates to a seat post for a bicycle. The present invention has particular but not exclusive application for fitting an additional seat to a bicycle. The patent specification describes this use but it is by way of example only and the invention is not limited to this use.

### BACKGROUND OF THE INVENTION

Competitive cycling encompasses various disciplines, among which BMX racing and BMX freestyle gained significant popularity in the 1980s and have since become recognized Olympic events, capturing the attention of athletes and spectators alike.

Typically when competing in BMX events, the seats are in a lowered position so that they don't interfere with the cyclists who would pedal the bikes while avoiding a seated position.

A problem with having a seat that can be adjusted to a higher position is that the seat stem has to be longer, the additional length of the seat stem adds weight to the bike regardless of what type of material it is made of, such additional material can make the difference between winning and losing.

Conversely, forgoing the option of an adjustable seat height poses challenges when it comes to post-event warm-down routines. Without the luxury of a higher seat, athletes may find it uncomfortable and cramped to sit in a lower position, thereby increasing the risk of potential injuries.

One known approach to address this predicament involves using a dedicated bike specifically designed for warm-down purposes. While this might be an acceptable solution for elite athletes benefiting from sponsorships and financial support, it introduces supplementary costs and logistical complexities. Furthermore, this approach may not be feasible or practical for aspiring BMX athletes who are just embarking on their journey in the sport.

### OBJECT OF THE INVENTION

It is an object of the present invention to overcome or at least alleviate one or more of the above mentioned problems with BMX bikes and/or provide the consumer with a useful or commercial choice.

### SUMMARY OF THE INVENTION

In one aspect, the present invention broadly resides in a seat post for a BMX bike having
a first elongate portion; and
a second elongate portion having a smaller external diameter than the first elongate portion,
wherein the seat post steps down or tapers in diameter from the first elongate portion to the second elongate portion.

Preferably, the first elongate portion is substantially circular in cross section.

Preferably the first elongate portion is adapted to operatively attach to a second bicycle seat. Preferably the first elongate portion has an opening extending in the direction of a longitudinal axis of the seat post. Preferably the opening is adapted to receive a second bicycle seat post. More preferably the opening is adapted to receive a second bicycle seat post with a second bicycle seat attached. Preferably the second bicycle seat post is different to the seat post.

In another embodiment, the first elongate portion is adapted to be attached to a second bicycle seat

Preferably the seat post further includes an attachment means associated with the first elongate portion. Preferably the attachment means is a clamp. Preferably the attachment means is adapted to secure the second bicycle seat post within the opening.

Preferably the first elongate portion includes a slot. Preferably the slot enables a portion of the first elongate portion to constrict. Preferably the portion of the first elongate portion is constricted using the attachment means. Preferably the constriction of the portion of the first elongate portion is adapted to secure the second bicycle seat post within the opening of the first elongate portion.

Preferably, the second elongate portion is substantially circular in cross section.

Preferably the second elongate portion is adapted to be received at least partially within a first bicycle seat and/or a first bicycle seat post. Preferably the first bicycle seat post is different to the second bicycle seat post and the seat post.

Preferably the second elongate portion includes an alignment portion. Preferably the alignment portion inhibits rotation of the seat post relative to the first bicycle seat post and/or the first bicycle seat. Preferably the alignment portion includes a slot. Preferably the slot is adapted to engage with a part of the first bicycle seat post. More preferably the slot is adapted to engage with a pin of the first bicycle seat post. Preferably the first bicycle seat post includes a first bicycle seat attached thereto. Preferably the first bicycle seat post includes an opening to accept the second elongate portion. Preferably the first bicycle seat attached to the first bicycle seat post includes an opening to enable the second elongate portion to be received in the opening of the first bicycle seat post.

Preferably the seat post steps down in diameter from the first elongate portion to the second elongate portion. Preferably the step down in diameter creates an abutment portion. Preferably the abutment portion is adapted to abut the first bicycle seat.

In another aspect, the present invention broadly resides in a seat post assembly for a BMX bike having
a first elongate portion;
a second elongate portion extending from the first elongate portion, the second elongate portion having a smaller external diameter than the first elongate portion; and
a first bicycle seat having an opening to accept the second elongate portion.
wherein the seat post steps down or tapers in diameter from the first elongate portion to the second elongate portion, and wherein the second elongate portion is adapted to be received by the first bicycle seat.

Preferably the seat post assembly further includes a first bicycle seat post associated with the first bicycle seat. Preferably the first bicycle seat post includes an opening to receive the second elongate portion. Preferably the first bicycle seat post is attached or attachable to the first bicycle seat. In one embodiment the first bicycle seat post is integrally formed with the first bicycle seat.

Preferably the first elongate portion is a first elongate portion as described in this specification.

Preferably the first elongate portion is adapted to operatively attach to a second bicycle seat. Preferably the first elongate portion has an opening extending in the direction of a longitudinal axis of the seat post. Preferably the opening is adapted to receive a second bicycle seat post. More preferably the opening is adapted to receive a second bicycle seat post with a second bicycle seat attached. Preferably the second bicycle seat post is different to the seat post.

Preferably the seat post assembly further includes an attachment means associated with the first elongate portion. Preferably the attachment means is a clamp. Preferably the attachment means is adapted to secure the second bicycle seat post within the opening.

Preferably the second elongate portion is a second elongate portion as described in this specification.

Preferably the opening in the first bicycle seat aligns with the opening in the first bicycle seat post.

Preferably the first bicycle seat post includes an alignment means. Preferably the alignment means inhibits the second elongate portion from rotating when the second elongate portion is located within the opening of the first bicycle seat post. Preferably the alignment means is an alignment member located within the opening of the first bicycle seat post. Preferably the alignment member is located transversely to a longitudinal axis of the opening of the first bicycle seat post. Preferably the alignment member is a rod or pin.

In one embodiment, the second elongate portion includes a retention means to releasably retain the second elongate portion in the opening of the first bicycle seat post. Preferably the retention means includes one or more detents that are adapted to engage with the alignment member. Preferably the one or more detents and the alignment member interact via a friction fit.

In one embodiment, the seat post is made of metal. In another embodiment the seat post is made of a composite material. Preferably the composite material is a carbon fibre composite material. In another embodiment, the seat post is made of a plastic material.

In one embodiment, the first bicycle seat post is made of metal. In another embodiment the first bicycle seat post is made of a composite material. Preferably the composite material is a carbon fibre composite material. In another embodiment, the first bicycle seat post is made of a plastic material.

Preferably the first bicycle seat is made of a plastic material. In another embodiment the first bicycle seat is made of a composite material. Preferably the composite material is a carbon fibre composite material. Preferably the seat includes padding.

In a further aspect, the present invention broadly resides in a method of using a seat post for a BMX bike, including the steps of
inserting a second elongate portion of the seat post into an opening of a first bicycle seat attached to the BMX bike;
locating a first elongate portion of the seat post adjacent the opening of the first bicycle seat, the first elongate portion of the seat post having a larger external diameter than the second elongate portion; and
operatively attaching a second seat to the first elongate portion of the seat post.

Preferably the seat post is a seat post as described in this specification.

Preferably the step of operatively attaching a second bicycle seat to the first elongate portion of the seat post includes inserting a second bicycle seat post into an opening of the of the first elongate portion. Preferably the step of operatively attaching a second bicycle seat to the first elongate portion of the seat post further includes the step of attaching the second bicycle seat to the second bicycle seat post.

Preferably the method further includes the step of inhibiting rotation of the seat post relative to the first bicycle seat.

Preferably the method further includes the step of adjusting the position of the second bicycle seat post within the opening of the of the first elongate portion.

Preferably the method further includes the step of releasably securing the second bicycle seat post within the opening of the of the first elongate portion.

It will be understood that the term diameter can refer to a maximum width for non-circular cross sections of the seat post.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is an exploded view of a seat post assembly according to an embodiment of the present invention;

FIG. 2 is a perspective view of the seat post assembly of FIG. 1;

FIG. 3 is a front view of the seat post assembly of FIG. 2; and

FIG. 4 is a section view of the seat post assembly of FIG. 3.

### DETAILED DESCRIPTION OF THE PREFERRED EMBODIMENT

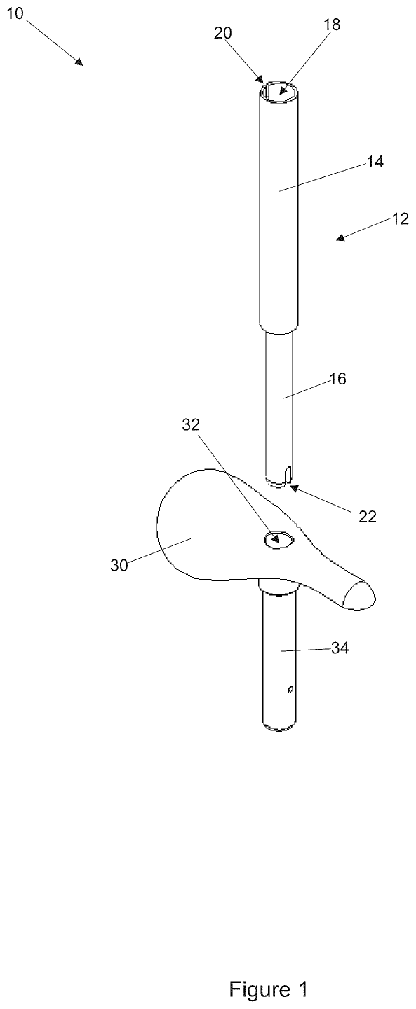

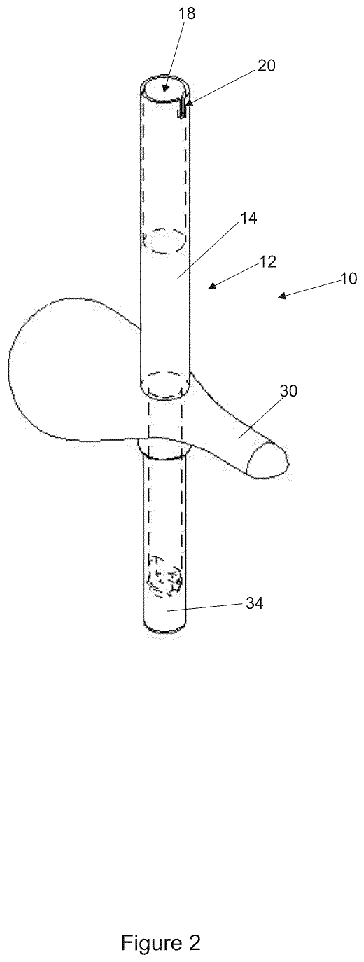

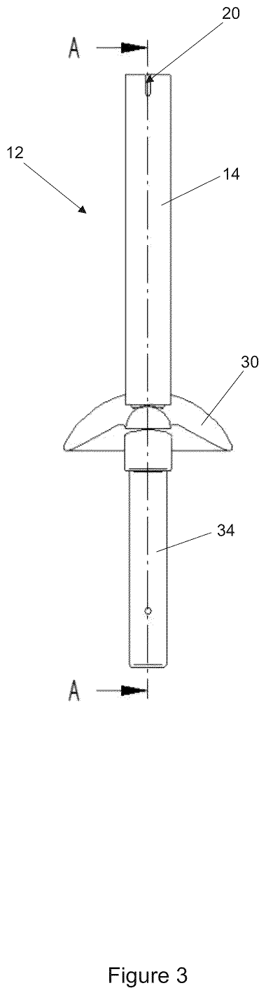

With reference to FIGS. 1 to 4 there is shown a seat post assembly 10 according to an embodiment of the present invention. The seat post assembly 10 has a seat post 12. The seat post 12 has a first elongate portion 14 extending from a second elongate portion 16.

The seat post assembly 10 has a first bicycle seat 30 attached to a first bicycle seat post 34. The first bicycle seat 30 and the first bicycle seat post 34 has an opening 32. The opening 32 is adapted to receive the second elongate portion 16.

The first elongate portion 14 has a larger external diameter than the second elongate portion 16. The first elongate portion 14 has an opening 18. The opening 18 can accept a second seat post (not shown) which would typically have a second bicycle seat (not shown) attached.

The first elongate portion 14 also has a slot 20 such that a part of the first elongate portion 14 can be constricted to secure a second seat post in the opening 18. An attachment means such as a clamp (not shown) can be placed around the top part of the first elongate portion 14 so that a part of the first elongate portion can be constricted.

The second elongate portion 16 includes an alignment portion in the form of a slot 22. The slot 22 is adapted to engage with a pin 36 in first bicycle seat post 34 to inhibit the seat post 12 from rotating relative to the seat 30 and the first bicycle seat post 34.

The second elongate portion 16 has a smaller diameter than an internal diameter of the opening 18 of the first elongate portion.

The internal diameter of the opening 18 is substantially the same as the external diameter of the first bicycle seat post 34.

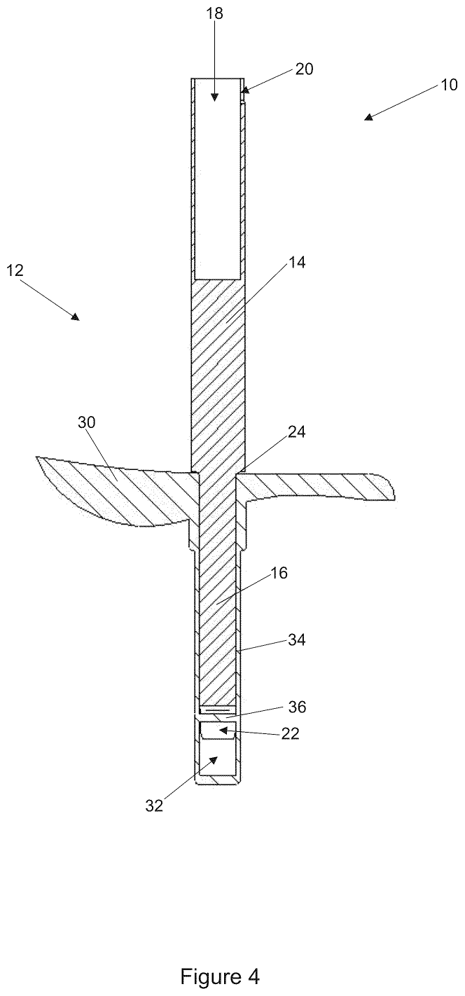

The seat post 12 steps down from the first elongate portion 14 to the second elongate portion 16 to create an abutment portion 24. The abutment portion 24 is adapted to abut the seat 30 (best seen in FIG. 4).

In use, after an event, the seat post 12, with a second bicycle seat post (not shown) and a second bicycle seat (not shown) attached, is inserted into the opening 32 of the seat 30 and the first bicycle seat post 34 attached to a bike (not shown), enabling a rider to warm down after an event while seated on a higher seat to avoid cramping their legs. For an event, the seat post 12 and second bicycle seat post and second bicycle seat are removed so they don't add unnecessary weight to the bike.

### Advantages

An advantage of the preferred embodiment of the seat post assembly includes the ability to quickly and removably add an extension bike seat to an existing bike seat without having to remove the existing bike seat from the bike. Another advantage of the preferred embodiment of the seat post assembly includes no additional weight when the extension bike seat is removed from the bike. A further advantage of the preferred embodiment of the seat post assembly includes the ability to adjust the height of the extension bike seat relative to the seat post.

### Variations

While the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A seat post for a BMX bike having
a first elongate portion; and
a second elongate portion having a smaller external diameter than the first elongate portion,
wherein the seat post steps down or tapers in diameter from the first elongate portion to the second elongate portion.

2. The seat post as claimed in claim 1, wherein the first elongate portion has an opening extending in the direction of a longitudinal axis of the seat post, the opening adapted to receive a second bicycle seat post with a second bicycle seat attached.

3. The seat post as claimed in claim 2, wherein the seat post further includes an attachment means associated with the first elongate portion.

4. The seat post as claimed in claim 3, wherein the attachment means is a clamp adapted to secure the second bicycle seat post within the opening.

5. The seat post as claimed in claim 1, wherein the second elongate portion is adapted to be received at least partially within a first bicycle seat and/or a first bicycle seat post.

6. The seat post as claimed in claim 5, wherein the seat post steps down in diameter from the first elongate portion to the second elongate portion creating an abutment portion adapted to abut the first bicycle seat.

7. The seat post as claimed in claim 5 or claim 6, wherein the second elongate portion includes an alignment portion adapted to engage with a part of the first bicycle seat post to inhibit rotation of the seat post relative to the first bicycle seat post

8. The seat post as claimed in claim 1, wherein the first elongate portion and the second elongate portion are substantially circular in cross section.

9. A seat post assembly for a BMX bike having
a first elongate portion;
a second elongate portion extending from the first elongate portion, the second elongate portion having a smaller external diameter than the first elongate portion; and
a first bicycle seat having an opening to accept the second elongate portion. wherein the seat post steps down or tapers in diameter from the first elongate portion to the second elongate portion, and wherein the second elongate portion is adapted to be received by the first bicycle seat.

10. The seat post assembly as claimed in claim 9, further including a first bicycle seat post associated with the first bicycle seat.

11. The seat post assembly as claimed in claim 10, wherein the first bicycle seat post includes an opening to receive the second elongate portion.

12. The seat post assembly as claimed in claim 11 wherein the first bicycle seat post is attached or attachable to the first bicycle seat.

13. The seat post assembly as claimed in claim 11, wherein the first bicycle seat post includes an alignment means which inhibits the second elongate portion from rotating when the second elongate portion is located within the opening of the first bicycle seat post.

14. The seat post assembly as claimed in claim 13 wherein the alignment means is an alignment member located within the opening of the first bicycle seat post.

15. The seat post assembly as claimed in 14 wherein the alignment member is located transversely to a longitudinal axis of the opening of the first bicycle seat post and is adapted to engage with a slot in the second elongate portion.

16. A method of using a seat post for a BMX bike, including the steps of
inserting a second elongate portion of the seat post into an opening of a first bicycle seat attached to the BMX bike;
locating a first elongate portion of the seat post adjacent the opening of the first bicycle seat, the first elongate portion of the seat post having a larger external diameter than the second elongate portion; and
operatively attaching a second seat to the first elongate portion of the seat post.

17. The method as claimed in claim 16, wherein the step of operatively attaching a second bicycle seat to the first elongate portion of the seat post includes inserting a second bicycle seat post into an opening of the of the first elongate portion.

18. The method as claimed in claim 17, further including the step of attaching the second bicycle seat to the second bicycle seat post.

19. The method as claimed in claim 16, further including the step of inhibiting rotation of the seat post relative to the first bicycle seat.

20. The method as claimed in claim 16, further including the step of releasably securing the second bicycle seat post within the opening of the of the first elongate portion.
